(19) United States
(12) Patent Application Publication
(10) Pub. No.: US 2019/0378089 A1
(43) Pub. Date: Dec. 12, 2019

(54) UNDERUTILIZED ALLOTMENT FEE

(71) Applicants: Joann E. Jancik, EAGAN, MN (US); Neeraj Kumar, EAGAN, MN (US)

(72) Inventors: Joann E. Jancik, EAGAN, MN (US); Neeraj Kumar, EAGAN, MN (US)

(73) Assignee: Unisys Corporation, Blue Bell, PA (US)

(21) Appl. No.: 16/005,803

(22) Filed: Jun. 12, 2018

(51) Int. Cl. G06Q 10/08; G06Q 10/02

(52) U.S. Cl. CPC G06Q 10/08345; G06Q 30/04; G06Q 10/0875; G06Q 10/02

(57) ABSTRACT

Systems, apparatuses, and methods that generate supplemental air waybill that includes the underutilized allotment fee. An apparatus includes a processor. The processor is configured to execute the step of collecting allotment contract information, calculating an allotment total due amount using the allotment contract information, collecting active allotment information, calculating an active allotment due amount using the active allotment information, and calculating an underutilized allotment fee using the allotment total due amount and the active allotment due amount.

### FIELD OF THE DISCLOSURE

The instant disclosure relates generally to the shipping industry. More specifically, this disclosure relates to methods, apparatuses, and systems that calculate underutilized allotment fee according to an allotment contract and active allotment.

### BACKGROUND

A service provider, e.g., an airline, may provide services to ship goods. A service requester may be a customer or company that needs shipping services to ship goods. The service requester may promise the service provider a certain quantity of goods to be shipped in exchange for a lower shipping rate, forming an allotment contract between the service requester and service provider. In order to accommodate the quantity of goods promised by the service requester, the service provider would create an allotment reserving sufficient shipping capacity for a specific flight, flight segment, and date range. Provided the total shipping capacity for a specific flight, fight segment, and date range is constant, the service provider loses other business opportunities by creating the allotment. If the service requester eventually does not ship the promised quantity of goods, an underutilized allotment is incurred. Underutilized allotment may cause significant financial loss to the service provider.

Currently, the service provider has no way to know whether the service requester will ship sufficient quantity of goods that fulfill the capacity reserved until the goods are actually loaded and shipped. The embodiments herein disclosed allows for real-time information gathering such that as soon as the goods are received by the service provider, an underutilized allotment can be calculated immediately. The service provider can immediately generate a notice or a new contract notifying service requester of the underutilized allotment. The embodiments of apparatuses, systems, and methods disclosed herein may reduce the financial burden of the service provider by calculating underutilized allotment fees and creating supplemental air waybills (AWBs) to be invoiced to the service requester for the underutilized allotment fees.

### SUMMARY

The instant disclosure relates generally to the shipping industry. More specifically, this disclosure relates to methods, apparatuses, and systems that calculate underutilized allotment fee according to allotment contract and active allotment. According to one embodiment, a method includes collecting, by a processor, allotment contract information. The method further includes calculating, by the processor, an allotment total due amount using the allotment contract information. The method further includes collecting, by the processor, active allotment information. The method further includes calculating, by the processor, an active allotment due amount using the active allotment information. The method further includes calculating, by the processor, an underutilized allotment fee using the allotment total due amount and the active allotment due amount.

Currently, the service provider has no way to know whether the service requester will ship sufficient quantity of goods that fulfill the capacity reserved until the goods are actually loaded and shipped. The embodiments herein disclosed allows for real-time information gathering such that as soon as the goods are received by the service provider, an underutilized allotment can be calculated in real-time immediately. The service provider can immediately generate a notice or a new contract notifying service requester of the underutilized allotment. In one embodiment, the service provider may charge additional fee based on the real-time calculated underutilized allotment before shipping. In another embodiment, the service provider can generate a new contract based on the real-time calculated underutilized allotment before shipping.

According to another embodiment, a computer program product includes a non-transitory computer-readable medium comprising instructions which, when executed by a processor of a computing system, cause the processor to perform the following steps. The steps include collecting allotment contract information. The steps include calculating an allotment total due amount using the allotment contract information. The steps include collecting active allotment information. The steps include calculating an active allotment due amount using the active allotment information. The steps include calculating an underutilized allotment fee using the allotment total due amount and the active allotment due amount.

According to yet another embodiment, an apparatus includes a memory. The apparatus further includes a processor coupled to the memory. The processor is configured to execute the following steps. The steps include collecting allotment contract information. The steps include calculating an allotment total due amount using the allotment contract information. The steps include collecting active allotment information. The steps include calculating an active allotment due amount using the active allotment information. The steps include calculating an underutilized allotment fee using the allotment total due amount and the active allotment due amount.

Without limitation, the embodiments of methods, apparatuses, and systems disclosed herein may be implemented by a logistics managing system, e.g., logistics management system (LMS) by Unisys. It is noted the embodiments disclosed herein may be broadly implemented among various applications in the shipping industry, not limited to the logistics managing system.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 is a flow chart illustrating a method to calculate an underutilized allotment fee according to one embodiment of the disclosure.

FIG. 2 is a flow chart illustrating a method to calculate an allotment total due amount according to one embodiment of the disclosure.

FIG. 3 is a flow chart illustrating a method to calculate an active allotment due amount according to one embodiment of the disclosure.

FIG. 4 is a flow chart illustrating a method to create a supplemental air waybill (AWB) according to one embodiment of the disclosure.

FIG. 5 is a flow chart illustrating a method to create a supplemental AWB according to one embodiment of the disclosure.

FIG. 6 is a user interface showing allotment contract information according to one embodiment of the disclosure.

FIG. 7 is a block diagram illustrating a system according to one embodiment of the disclosure according to one embodiment of the disclosure.

FIG. 8 is a block diagram illustrating a computer system according to one embodiment of the disclosure.

FIG. 9A is a block diagram illustrating a server hosting an emulated software environment for virtualization according to one embodiment of the disclosure.

FIG. 9B is a block diagram illustrating a server hosing an emulated hardware environment according to one embodiment of the disclosure.

### DETAILED DESCRIPTION

The term “operating system” is a set of instructions that can be executed by a processor of a computer. An operating system supports the basic functionalities of a computer. An operating system may be an emulated operating system or a non-emulated operating system, for example, OS 2200, Eclipse 2200, System Architecture Interface Layer (SAIL), Linux, Windows, Java, Unix, or the like.

The term “instruction” means a processor-executable instruction, for example, an instruction written as programming codes. An instruction may be executed by any suitable processor, for example, x86 processor. An instruction may be programmed in any suitable computer language, for example, machine codes, assembly language codes, C language codes, C++ language codes, Fortran codes, Java codes, Matlab codes, or the like.

A “computer-readable medium” holds the data in a data storage medium for a period of time that is not transient. The term computer-readable medium may be used interchangeably with non-transient computer-readable medium. A computer-readable medium may be volatile memory that loses its memory when power is off, e.g., random access memory (RAM), dynamic random access memory (DRAM), etc. A computer-readable medium may be non-volatile memory that does not lose its memory when power is off, e.g, hard disk, flash memory, optical disk, magnetic tape, etc. Computer-readable medium includes, e.g., random access memory (RAM), dynamic random access memory (DRAM), read only memory (ROM), electrically erasable programmable read-only memory (EEPROM), Flash memory, NAND/NOR gate memory, hard disk drive, magnetic tape, optical disk, compact disk (CD), or the like.

An “allotment contract” is a contract for shipping goods, wherein a service requester may promise to ship a certain weight/quantity of goods, and a service provider reserves a shipping capacity for a specific flight, flight segment, and date range to accommodate for the promised weight/quantity of goods. An allotment contract may include the following information: weight commitment, contract rate for each unit weight, underutilized allotment percentage rate, etc. This information may be called “allotment contract information.” It is noted, the allotment contract information mentioned above are exemplary only and is in no way limiting the scope of the disclosure.

An “allotment total due amount” may be an amount of money a service provider expects to collect from a service requester, if the committed allotment is fulfilled by the service requester. An allotment total due amount can be calculated from the information specified in an allotment contract.

The term “weight” in this disclosure may refer to actual weight (e.g., gram, kilogram, ounce, pound, etc) or dimensional weight, whichever is appropriate in the situation. Dimensional weight is calculated using the dimension and the actual weight of the shipped packages according to industrial standards.

A “hard block (HB)” is one kind of allotment contract. “HB” and “HB contract” may be used interchangeably when appropriate. In one embodiment, under an HB contract, a service requester may promise to fulfill a weight commitment of an allotment. If the service requester is not able to meet the weight commitment of an allotment, the service requester may be financially responsible to pay for the full price of an allotment total due amount. In one embodiment, the allotment total due amount may be calculated as: allotment total due amount=weight commitment×contract rate for each unit weight. In another embodiment, under an HB contract, an underutilized allotment fee may be the full contract price of the unused allotment. In one embodiment, an underutilized allotment fee may be calculated as: underutilized allotment fee=allotment total due amount−active allotment due amount=(weight commitment×contract rate for each unit weight)−(actual weight used in an active allotment×contract rate for each unit weight).

For example, in one HB contract, a service requester may promise 100-pound weight commitment of an allotment at a contracted rate of $10/pound. The service requester may eventually only use 80 pounds of the committed allotment (i.e., actual weight used in an active allotment is 80 pounds). The underutilized allotment fee may be calculated as: [100 pounds (weight commitment)−80 pounds (actual weight used in an active allotment)]×$10/pound (contract rate)=$200.

A “soft block (SB)” is one kind of allotment contract. “SB” and “SB contract” may be used interchangeably when appropriate. In one embodiment, under an SB contract, a service requester may promise to fulfill a weight commitment of an allotment. If the service requester is not able to meet the weight commitment of an allotment (i.e., there is an underutilized allotment), the service requester may be financially responsible to pay for the underutilized allotment at a portion of the underutilized allotment fee.

For example, in one SB contract, a service requester may promise a 100-pound weight commitment of an allotment at a contract rate of $10/pound. The SB contract may further specify that underutilized allotment percentage rate is 90% of the underutilized allotment fee. The service requester may eventually only used 80 pounds of the committed allotment (i.e., actual weight used in an active allotment is 80 pounds). The underutilized allotment fee may be calculated as [100 pounds (weight commitment)−80 pounds (actual weight used in an active allotment)]×$10/pound (contract rate)×0.90% (underutilized allotment percentage rate)=$180.

A “contract rate” is a contracted price specified in an “allotment contract” for shipping goods. The contract rate is specified for each unit weight of the goods, e.g., $10/pound.

An “active allotment” refers to the allotment that is actually used by a service requester, not what was promised in the allotment contract or claimed by the service requester. In general, information of “active allotment” may be the information actually measured or verified by the service provider, e.g., weights or dimensions of the goods measured by the airlines.

An “actual weight used in an active allotment” may be the weight of the allotment that is actually shipped by the service requester. In one embodiment, an underutilized allotment fee is incurred when the “actual weight used in an active allotment” is less than a weight commitment promised by a service requester in an HB or SB contract.

An “underutilized allotment percentage rate” is specific for SB. In an SB contract, an underutilized allotment percentage rate specifies a percentage of the underutilized allotment fee that would otherwise be charged in an HB.

An “active allotment due amount” may be an amount of money calculated using contract rate (e.g., for each unit weight) multiply by the quantity of an active allotment (i.e. allotment that is actually used by the service requester).

An “underutilized allotment fee” is a fee charged by the service provider for underutilized allotment. In one embodiment, an underutilized allotment fee may be incurred, if a service requester does not fulfill a weight commitment. In one embodiment, underutilized allotment fee=allotment total due amount−active allotment due amount, if the allotment contract is an HB contract. In another embodiment, underutilized allotment fee=(allotment total due amount−active allotment due amount)×underutilized allotment percentage rate, if the allotment contract is an SB contract.

An “supplemental air waybill (AWB)” is a bill that charges a service requester for a variety of fees including the underutilized allotment fee.

An “underutilized allotment tolerance amount” may be a certain tolerance that a service provider sets so that no extra charge may be generated against the service requestor if (allotment total due amount)−(active allotment due amount) is within the underutilized allotment tolerance amount. For example, in one embodiment, an HB contract includes a weight commitment of 100 pounds contracted at $10/pound. An underutilized allotment tolerance amount is 5% of the allotment total due amount (100 pounds×$10/pound=$1000). Thus, the underutilized allotment tolerance amount can be calculated as $1000×5%=$50. Thus, if (allotment total due amount, e.g., $1000)−(active allotment due amount) is within $50, then no extra charge is generated against the service requester.

A “change allotment deadline” is a deadline for changing a quantity of committed allotment. In one embodiment, the change allotment deadline may be specified in terms of hours before flight departure, e.g., 48 hours before flight departure.

For a more complete understanding of the disclosed systems and methods, reference is now made to the following descriptions taken in conjunction with the accompanying drawings.

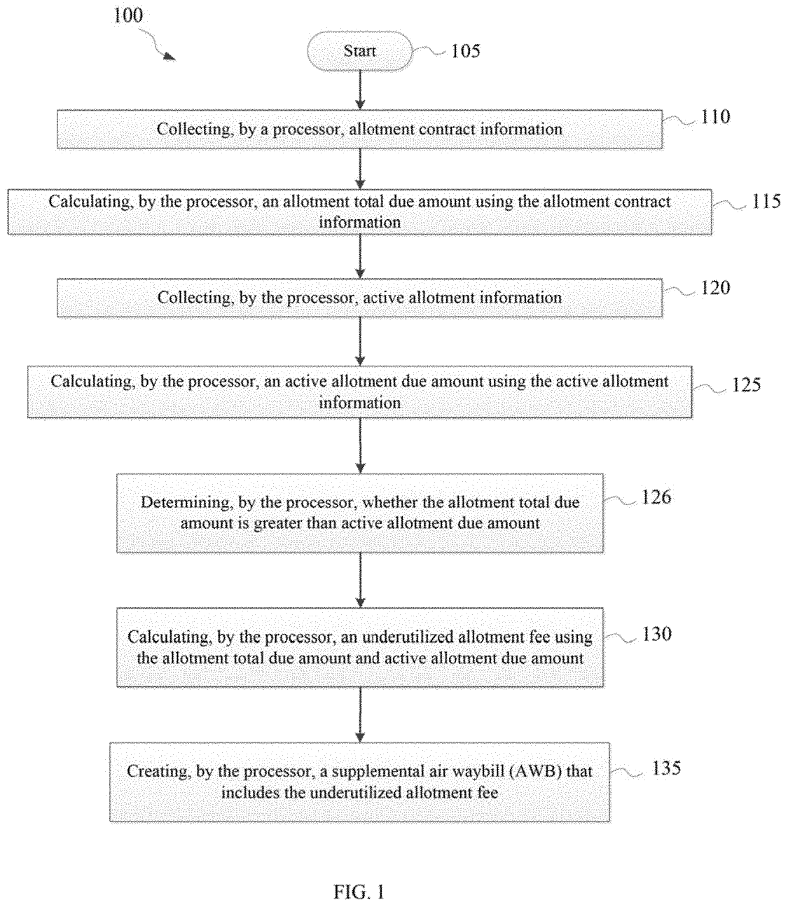

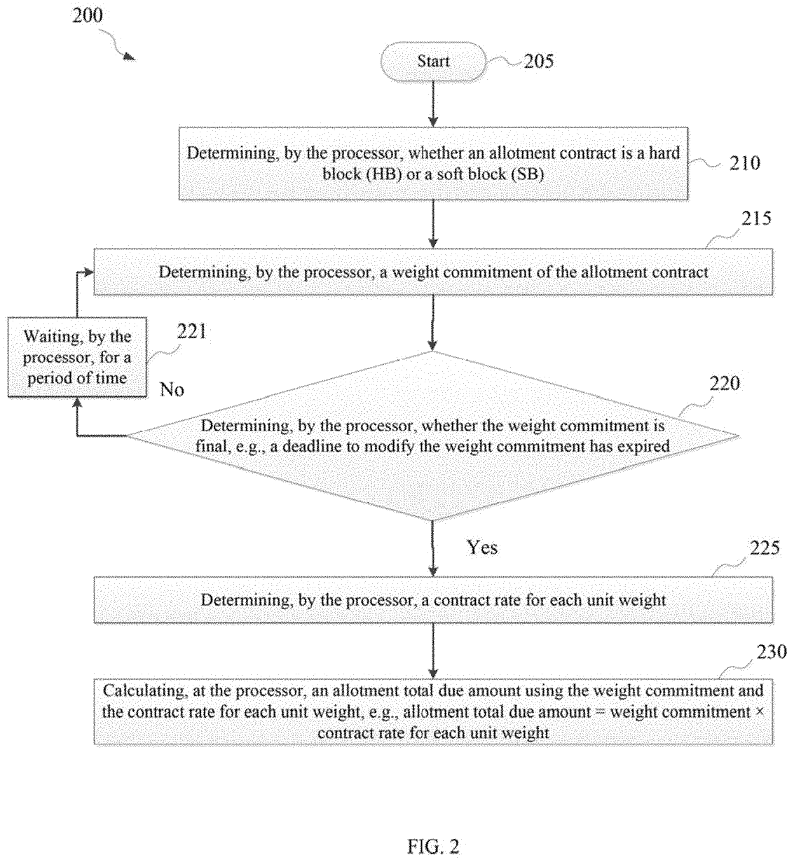

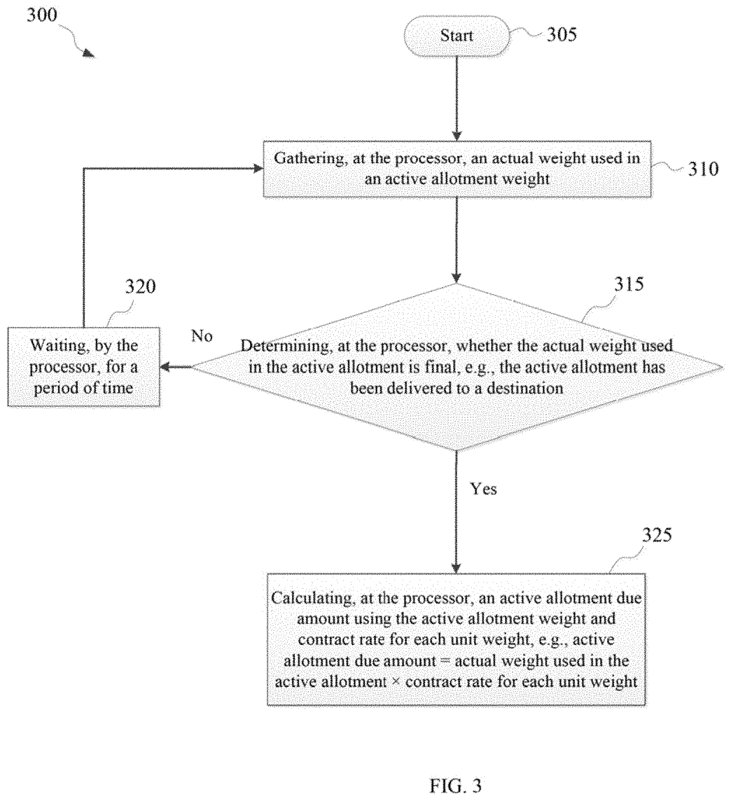

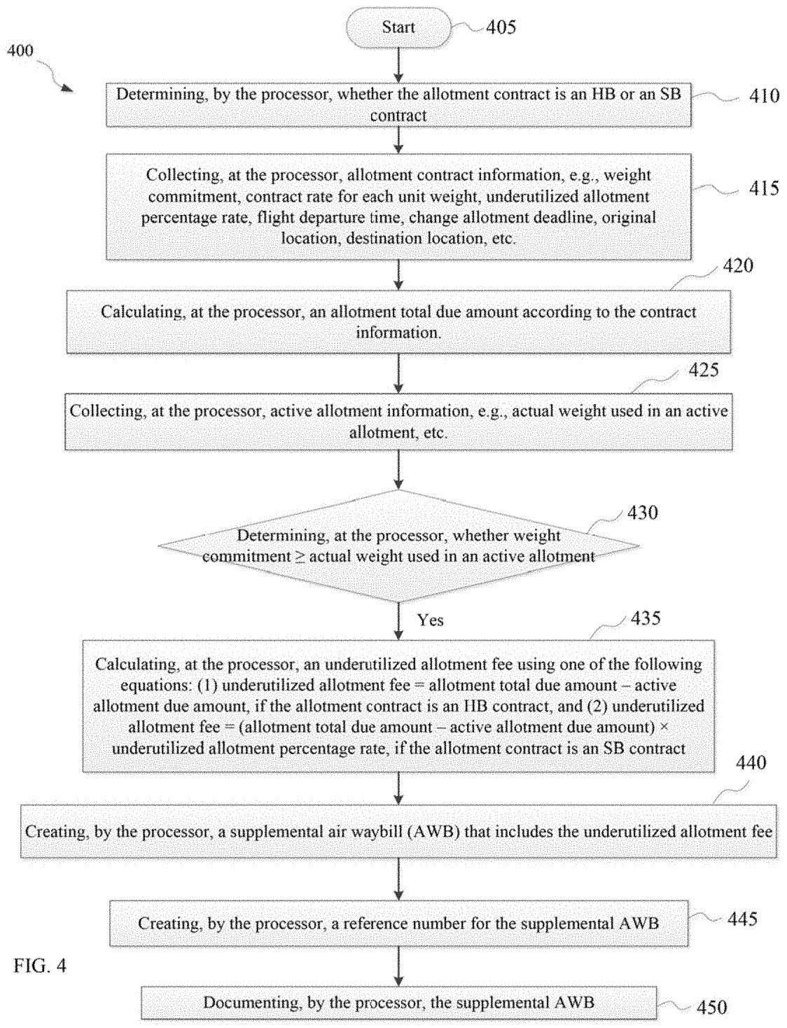

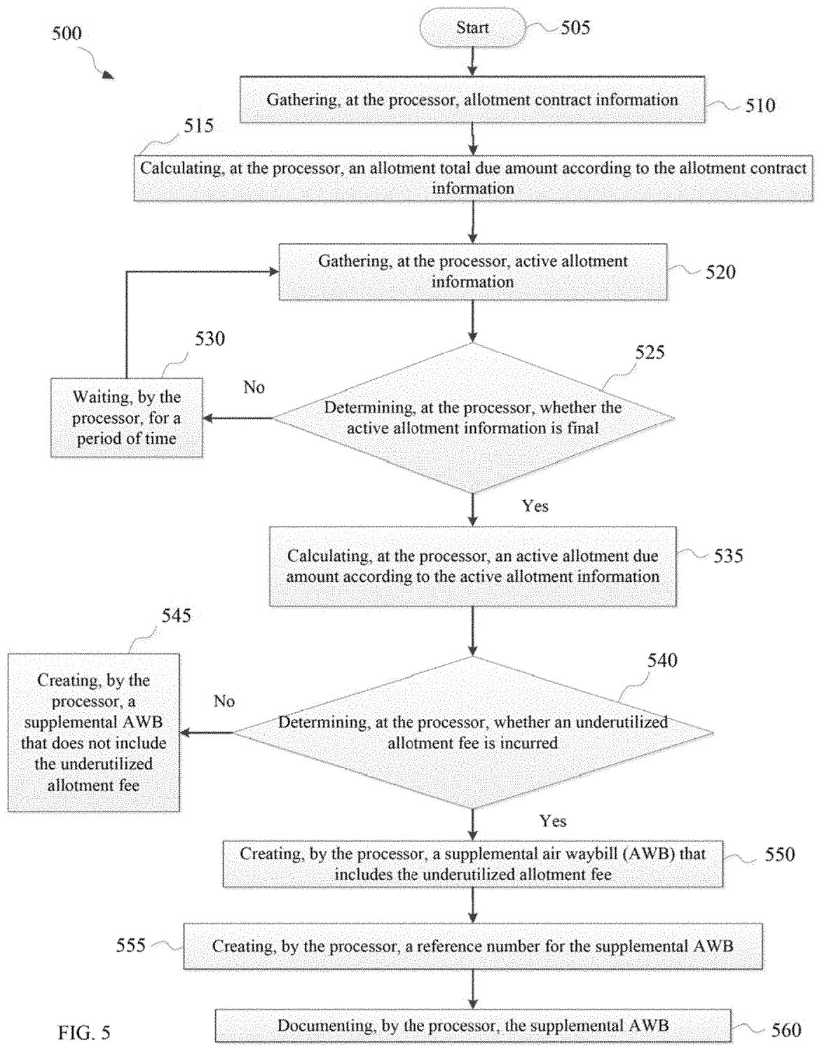

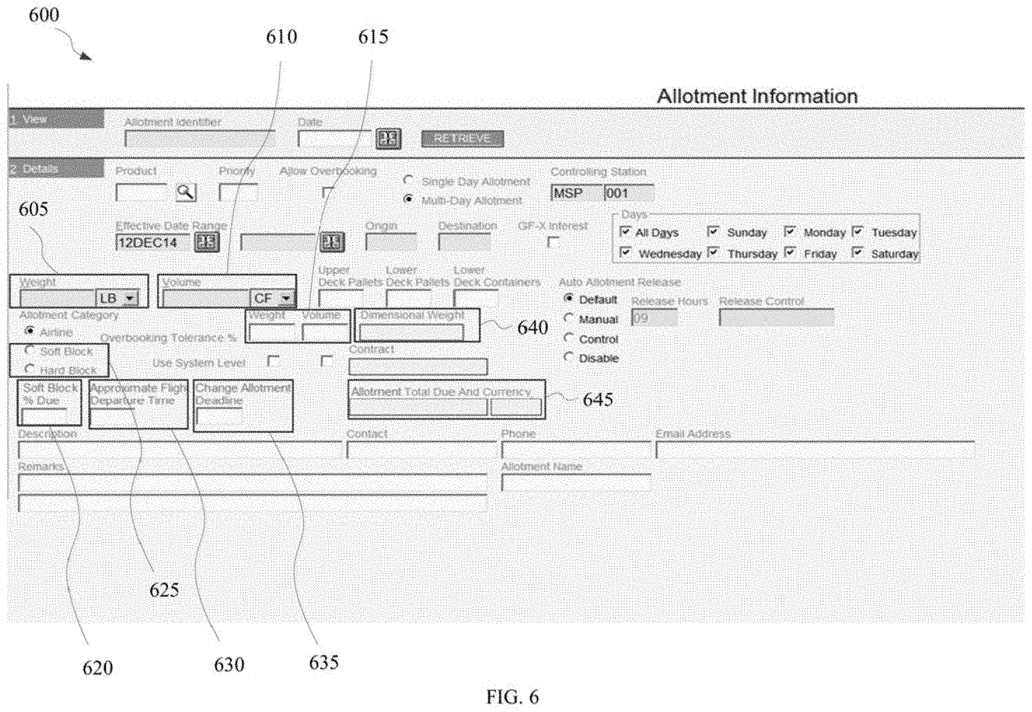

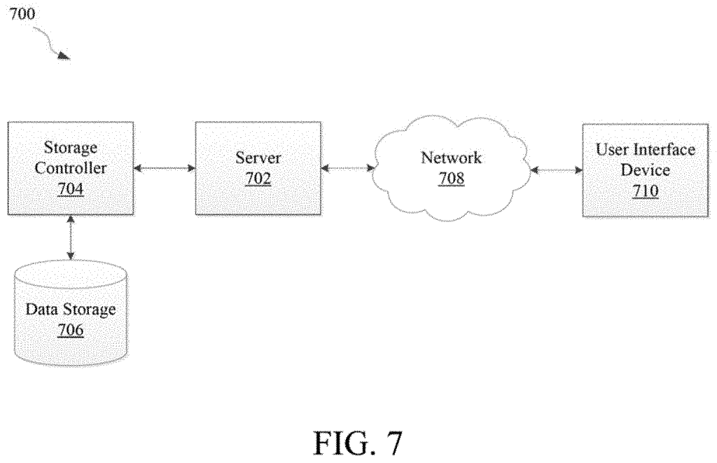

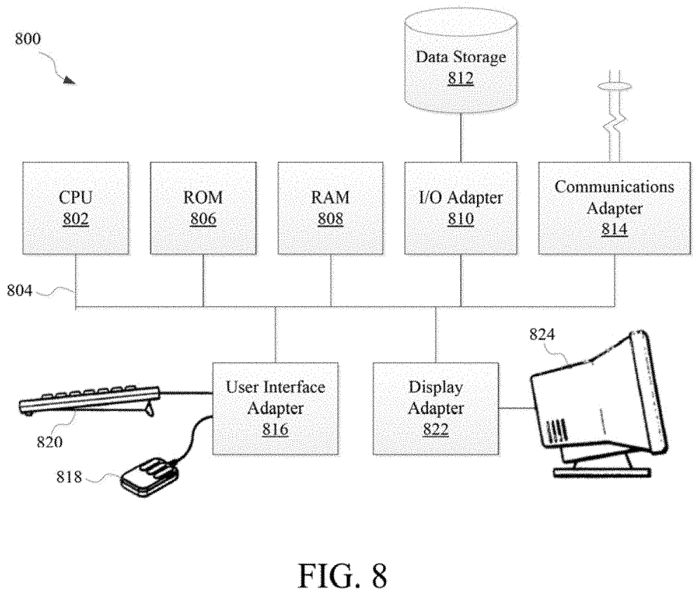

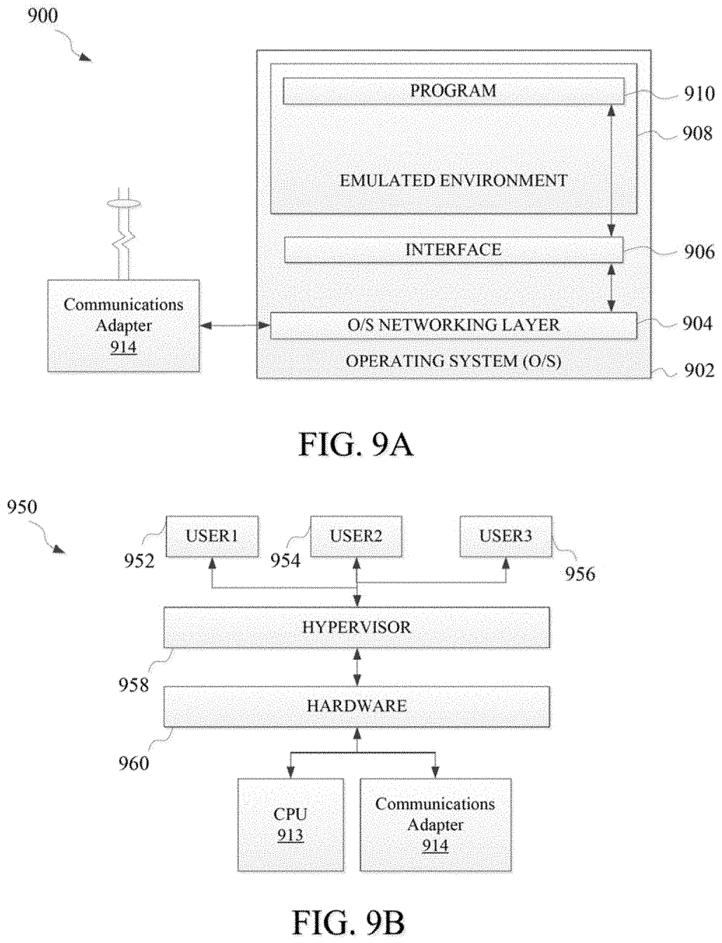

FIG. 1 is a flow chart illustrating a method 100 to calculate an underutilized allotment fee according to one embodiment of the disclosure. The method 100 may include, be used as part, or be used in combination with the method 200 in FIG. 2. For example, the method 200 in FIG. 2 may be one embodiment of 110 and 115 of the method 100. The method 100 may include, be used as part, or be used in combination with the method 300 in FIG. 3. For example, the method 300 in FIG. 3 may be one embodiment of 120 and 125 of the method 100. The method 100 may include, be used as part, or be used in combination with the method 400 in FIG. 4. For example, method 400 in FIG. 4 may be one embodiment of method 100. The method 100 may include, be used as part, or be used in combination with the method 500 in FIG. 5. For example, method 500 in FIG. 5 may be one embodiment of method 100. The method 100 may include or be implemented in the user interface 600 in FIG. 6. For example, without limitation, the soft/hard block 625, soft block % due 620, and approximate flight departure time 630 may be part of the information collected at block 110. In another example, without limitation, the allotment total due and currency 645 may be the allotment total due amount calculated in 115. The method 100 can be implemented in the system 700 as shown in FIG. 7. For example, without limitation, the instructions implementing method 100 may be stored in the data storage 706 or displayed on the user interface device 710. The method 100 can be implemented in the computer system 800 as shown in FIG. 8. For example, without limitation, the instructions implementing method 100 may be executed by the CPU 802 as shown in FIG. 8. The method 100 can be implemented on the servers 900 and 950 as shown in FIGS. 9A and 9B. For example, without limitation, the instructions implementing method 100 may be generated in the emulated environment 908 in as shown in FIG. 9A or executed by the CPU 913 as shown in FIG. 9B.

As shown in FIG. 1, the method 100 starts at block 105. The method 100 proceeds to block 110, which includes collecting, by the processor, allotment contract information. The method 100 proceeds to block 115, which includes calculating, by the processor, an allotment total due amount using the allotment contract information. The method 100 proceeds to block 120, which includes collecting, by the processor, active allotment information. The method 100 proceeds to block 125, which includes calculating, by the processor, an active allotment due amount using the active allotment due amount using the active allotment information.

The method 100 proceeds to block 130, which includes calculating, by the processor, an underutilized allotment fee using the allotment total due amount and allotment due amount. At block 130 the method may automatically reaches out to a data center independent form the service provider to acquire real-time allotment data. In another embodiment, this independent data center may be a data center operated by an airline that the service provider uses to ship the goods. In yet another embodiment, this independent data center may be a data center operated by a freight ship, freight truck, freight train company, or the like. In one embodiment, the service provider can acquire the data as soon the goods are loaded with the freight ship, freight truck, freight train company, or the like before the goods are received by the service provider. Therefore, if a new price or a new contract need to be generated, this can be done before the goods are received by the service provider. It is noted this ability to acquire such real-time underutilized allotment is a technological improvement that does not exist before this application.

The method 100 proceeds to block 135, which includes creating, by the processor, a supplemental air waybill (AWB) for the underutilized allotment fee.

At block 110, the processor collects allotment contract information. An allotment contract may include the following information: HB or SB, weight commitment, contract rate for each unit weight, underutilized allotment percentage rate, etc.

The allotment contract information collected at block 110 includes weight commitment. The weight commitment may be a certain quantity of weight of goods to be shipped promised by a service requester. In one embodiment, an underutilized allotment fee is generated if the weight commitment is not fulfilled by the service requester, regardless of any other factors.

The following paragraph is an example illustrating that an underutilized allotment fee under a hard block (HB) contract may be incurred strictly based on unfulfilled weight commitment according to one embodiment. An HB allotment contract includes a weight commitment of 2000 kg. The contract rate is l/kg. Thus, the allotment total due amount is 2000 kg×$1/kg=$2000. Under an HB contract, the underutilized allotment fee is calculated as: allotment total due amount−active allotment due amount. A service requester makes two bookings pursing this HB contract. The first booking is 2 kg. The second booking is 1990 kg. The booking weight charge for the first booking is $50, because the booking weight charge is (1) $50 minimum charge or (2) 2 kg×$1/kg=$2 whichever is greater. The active allotment due amount for the first booking is 2 kg×$1/kg=$2. Further, the booking weight charges for the second booking is $1990, because the booking weight charges is (1) $50 minimum charge or (2) 1990 kg×$1$1/kg=$1990 whichever is greater. The active allotment due amount for the second booking is 1990 kg×$1/kg=$1990. The overall booking weight charges charged to the customer for the two bookings in this active allotment, is $2040=$50 (first booking)+$1990 (second booking). However, regardless that the overall booking weight charges for the active allotment due ($2040) is greater than the allotment total due amount ($2000), the underutilized allotment fee is still incurred because the weight commitment (2000 kg) is not fulfilled. Therefore, the underutilized allotment fee can be calculated as (allotment total due amount)−(active allotment due amount)=[2000 kg (weight commitment)×$1/kg (contract rate)]−[[2 kg (first booking)+1990 kg (second booking)]×$1/kg (contract rate)]=$8. This embodiment illustrates that, depending on how an allotment contract is negotiated, an underutilized allotment fee may be incurred strictly based on unfulfilled weight commitment.

The following paragraph is another example illustrating that an underutilized allotment fee under a soft block (SB) contract may be incurred strictly based on unfulfilled weight commitment according to one embodiment. An SB allotment contract includes a weight commitment of 2000 kg. The contract rate may be at $1/kg. Thus, the allotment total due amount is 2000 kg×$1/kg=$2000. Under an SB contract, the underutilized allotment fee is calculated as: (allotment total due amount−active allotment due amount)×underutilized allotment percentage rate. The underutilized allotment percentage rate may be at 10%. The minimum charge for one booking is $50. A service requester makes two bookings pursing this SB contract. The first booking is 2 kg. The second booking is 1990 kg. The booking weight charge for the first booking is $50, because the booking weight charge is (1) $50 minimum charge or (2) 2 kg×$1/kg=$2 whichever is greater. The active allotment due amount for the first booking is 2 kg×$1$1/kg=$2. Further, the booking weight charges for the second booking is $1990, because the booking weight charges is (1) $50 minimum charge or (2) 1990 kg×$1/kg=$1990 whichever is greater. The active allotment due amount for the second booking is 1990 kg, $1/kg=$1990. The overall booking weight charges charged to the customer for the two bookings in this active allotment, is $2040=$50 (first booking)+$1990 (second booking). However, regardless that the overall booking weight charges for the active allotment due ($2040) is greater than the allotment total due amount ($2000), the underutilized allotment fee is still incurred because the weight commitment (2000 kg) is not fulfilled. Therefore, the underutilized allotment fee can be calculated as (allotment total due amount−active allotment due amount)×10%={[2000 kg (weight commitment)×$1/kg (contract rate)]−[[2 kg (first booking)+1990 kg (second booking)]×$1/kg (contract rate)]}×10%=$0.8. This embodiment illustrates that, depending on how an allotment contract is negotiated, an underutilized allotment fee may be incurred strictly based on unfulfilled weight commitment.

The allotment contract information collected at block 110 may include contract rate for each unit weight (e.g., $10/pound).

The allotment contract information collected at block 110 may include underutilized allotment percentage rate. In one embodiment, if the allotment contract is an HB, the underutilized allotment percentage rate for each unit weight is 100% of the underutilized allotment fee, wherein the underutilized allotment fee is calculated as allotment total due amount−active allotment due amount. In one embodiment, if the allotment contract is an SB, the underutilized allotment percentage rate may be a portion of the underutilized allotment fee, wherein the underutilized allotment fee is calculated as allotment total due amount−active allotment due amount.

The allotment contract information collected at block 110 may include approximate flight departure time. The approximate flight departure time may indicate the expected departure time of the flight. In one embodiment, the approximate flight departure time may be manually entered by a worker of the service provider. In one embodiment, the approximate flight departure time may be rounded to each half hours, e.g., 12:30 pm, 1 pm, 1:30 pm, 2 pm, etc.

The allotment contract information collected at block 110 may include change allotment deadline. In one embodiment, the service provided may allow the service requester to change the weight commitment of the allotment contract until “change allotment deadline.” This change allotment deadline may be specified in terms of hours before the flight departure time, e.g., 48 hours before approximate flight departure time. In another embodiment, the change allotment deadline may be specified in terms of a specific date and time, e.g., 12 pm of Nov. 16, 2015. In one embodiment, under an HB contract, no change of allotment is allowed and there is no change allotment deadline. In another embodiment, under an SB contract, a change of allotment is specified in the SB contract, allowing some flexibility for the service requester to modify the shipping date.

The allotment contract information collected at block 110 may include origin location information, e.g., MSP airport. The allotment contract information collected at block 110 may further include destination location information, e.g., LAX airport.

It is noted that the above listed contract information that may be collected at block 110 by the processor are exemplary, and are in no way limiting the scope of the disclosure. Other information known to a person skilled in the art of shipping industry may also be included in the allotment contract information collected at block 110.

As shown in FIG. 1, at block 115, the processor calculates an allotment total due amount. In one embodiment, the processor calculates the allotment total due amount using the information collected at block 110. In one embodiment, the allotment total due amount may be calculated as: allotment total due amount=weight commitment×contract rate for each unit weight.

As shown in FIG. 1, at block 120, the processor collects an active allotment information. Active allotment information may refer to all information regarding the allotment that are actually used by the service requester, not what was promised in the allotment contract. Active allotment information may include actual weight used in an active allotment, or the like.

As shown in FIG. 1, at block 125, the processor calculates the active allotment due amount using the active allotment information. At block 125, the processor may also use information collected at block 110. In one embodiment, the active allotment due amount may be calculated as: active allotment due amount=actual weight used in an active allotment×contract rate for each unit weight.

As shown in FIG. 1, at block 126, the processor determines whether the allotment total due amount is greater than active allotment due amount. In one embodiment, the allotment total due amount is calculated using the allotment contract information collected at 110. In another embodiment, the active allotment due amount is calculated using the active allotment information collected at 120.

As shown in FIG. 1, at block 130, the processor calculates an underutilized allotment fee using the allotment total due amount and active allotment due amount. In one embodiment, the underutilized allotment fee may be incurred strictly on unutilized allotment weight as calculated as: (1) underutilized allotment fee=allotment total due amount−active allotment due amount, if the allotment contract is an HB contract; and (2) underutilized allotment fee=(allotment total due amount−active allotment due amount)×underutilized allotment percentage rate, if the allotment contract is an SB contract.

As shown in FIG. 1, at block 135, the processor creates a supplemental air waybill (AWB) that includes the underutilized allotment fee. The supplemental AWB may be billed to the service requester in addition to the individual bookings' total weight charges booked against the active allotment.

FIG. 2 is a flow chart illustrating a method 200 to calculate an allotment total due amount according to one embodiment of the disclosure. The method 200 may include, be used as part, or be used in combination with the method 100 in FIG. 1. For example, the method 200 in FIG. 2 may be one embodiment of 110 and 115 of the method 100. The method 200 may include, be used as part, or be used in combination with the method 300 in FIG. 3. For example, the method 200 in FIG. 2 and the method 300 in FIG. 3 may be used in combination as one embodiment of 110, 115, 120, and 125 of the method 100. The method 200 may include, be used as part, or be used in combination with the method 400 in FIG. 4. For example, method 200 may be one embodiment of blocks 410, 415, and 420 of method 400 in FIG. 4. The method 200 may include, be used as part, or be used in combination with the method 500 in FIG. 5. For example, method 200 may be one embodiment of blocks 510 and 515 of method 500 in FIG. 5. The method 200 may include or be implemented in the user interface 600 in FIG. 6. For example, without limitation, the soft/hard block 625 may be part of the information collected at block 210. In another example, without limitation, the weight 605 may be the weight commitment determined at block 215. The method 200 can be implemented in the system 700 as shown in FIG. 7. For example, without limitation, the instructions implementing method 200 may be stored in the data storage 706 or displayed on the user interface device 710. The method 200 can be implemented in the computer system 800 as shown in FIG. 8. For example, without limitation, the instructions implementing method 200 may be executed by the CPU 802 as shown in FIG. 8. The method 200 can be implemented on the servers 900 and 950 as shown in FIGS. 9A and 9B. For example, without limitation, the instructions implementing method 200 may be generated in the emulated environment 908 in as shown in FIG. 9A or executed by the CPU 913 as shown in FIG. 9B.

As shown in FIG. 2, the method 200 starts at block 205. The method 200 proceeds to block 210, which includes determining, by the processor, whether an allotment contract is an HB or an SB. The method 200 proceeds to block 215, which includes determining, by the processor, a weight commitment of the allotment contract. The method 200 proceeds to block 220, which includes determining, by the processor, whether the weight commitment is final, e.g., a deadline to modify the weight commitment has expired. The method 200 proceeds to block 225, which includes determining, by the processor, a contract rate for each unit weight, if the weight commitment is final. The method 200 proceeds to block 221, which includes waiting, by the processor, for a period of time, if the weight commitment is not final. After the waiting period, the method 200 proceeds back to block 215, determining the weight commitment one more time. The method 200, then, proceeds to block 230, calculating, at the processor, an allotment total due amount using the weight commitment and the contract rate for each unit weight.

As shown in FIG. 2, at block 210, the processor determines whether an allotment contract is HB or SB. In one embodiment, an HB may specify the underutilized allotment percentage rate to be 100%. In other words, in an HB, an underutilized allotment fee can be calculated as: (allotment total due amount−active allotment due amount)×underutilized allotment percentage rate, wherein the underutilized allotment percentage is 100%.

In another embodiment, an SB may specify the underutilized allotment percentage rate to be any percentage less than 100%. In one embodiment, an SB may specify the underutilized allotment percentage rate to be 1˜99%. In one embodiment of an SB, an underutilized allotment fee can be calculated as: (allotment total due amount−active allotment due amount)×underutilized allotment percentage rate, wherein the underutilized allotment percentage is 1˜99%.

As shown in FIG. 2, at block 215, the processor determines a weight commitment of the allotment contract. The weight commitment may be a certain quantity of weight promised by the service requester to ship with the service provider.

As shown in FIG. 2, at block 220, the processor determines whether the weight commitment is final. In one embodiment, the weight commitment is modifiable until a certain deadline, e.g., change allotment deadline 635 in FIG. 6. In one embodiment, at block 220, the processor will determine whether a current time has passed the certain deadline, so that the weight commitment may be final and may no longer be modified. If the weight commitment is final, then the method 200 proceeds to block 225. If the weight commitment is not final, then the method 200 proceeds to block 221, which includes waiting, by the processor, for a period of time. After block 221, the method 200 proceeds to block 215.

As shown in FIG. 2, at block 225, the processor determines a contract rate for each unit weight. This contract rate for each unit weight may be a price negotiated between a service requester and a service provider. In one embodiment, if the service requester may promise a relatively large weight commitment (e.g., 10,000 pounds), then the contract rate for each unit weight may be lower, e.g. $1/pound. In another embodiment, if the service requester promises a relatively small weight commitment (e.g., 1,000 pounds), then the contract rate for each unit weight may be higher, e.g., $10/pound.

As shown in FIG. 2, at block 230, the processor calculates an allotment total due amount using the weight commitment and the contract rate for each unit weight. In one embodiment, the allotment total due amount may be calculates as: allotment total due amount=weight commitment×contract rate for each unit weight.

FIG. 3 is a flow chart illustrating a method 300 to calculate an active allotment due amount according to one embodiment of the disclosure. The method 300 may include, be used as part, or be used in combination with the method 100 in FIG. 1. For example, the method 300 in FIG. 3 may be one embodiment of 120 and 125 of the method 100. The method 300 may include, be used as part, or be used in combination with the method 200 in FIG. 2. For example, the method 200 in FIG. 2 and the method 300 in FIG. 3 may be used in combination as one embodiment of 110, 115, 120, and 125 of the method 100. The method 300 may include, be used as part, or be used in combination with the method 400 in FIG. 4. The method 300 may include, be used as part, or be used in combination with the method 500 in FIG. 5. For example, method 300 may be an alternative embodiment of blocks 520, 525, and 535 of method 500 in FIG. 5. The method 300 may include or be implemented in the user interface 600 in FIG. 6. The method 300 can be implemented in the system 700 as shown in FIG. 7. For example, without limitation, the instructions implementing method 300 may be stored in the data storage 706 or displayed on the user interface device 710. The method 300 can be implemented in the computer system 800 as shown in FIG. 8. For example, without limitation, the instructions implementing method 300 may be executed by the CPU 802 as shown in FIG. 8. The method 300 can be implemented on the servers 900 and 950 as shown in FIGS. 9A and 9B. For example, without limitation, the instructions implementing method 300 may be generated in the emulated environment 908 in as shown in FIG. 9A or executed by the CPU 913 as shown in FIG. 9B.

As shown in FIG. 3, the method 300 starts at block 305. The method 300 proceeds to block 310, which includes gathering, at the processor, an actual weight used in an active allotment. The method 300 proceeds to block 315, which includes determining, at the processor, whether the actual weight used in an active allotment is final. If the actual weight used in an active allotment is not final, the method 300 proceeds to block 320, which includes waiting, by the processor, for a period of time. If the actual weight used in an active allotment is final, the method 300 proceeds to block 325, which includes calculating, at the processor, an active allotment due amount using the actual weight used in an active allotment and a contract rate for each unit weight.

As shown in FIG. 3, at block 310, the processor gathers an actual weight used in an active allotment. The actual weight used in an active allotment may be a weight of the active allotment measured by the service provider, rather than a weight claimed by the service requester. In one embodiment, the actual weight used in an active allotment may be measured at the original location, e.g., MSP airport. In another embodiment, the actual weight used in an active allotment may be measured at the destination location, e.g., LAX airport. In one embodiment, the actual weight used in an active allotment may be measured at some point before the active allotment is delivered.

As shown in FIG. 3, at block 315, the processor determines whether the actual weight used in an active allotment is final. In one embodiment, initially, a logistic managing system may automatically populate an actual weight used in an active allotment based on what is claimed by the service requester. However, the actual weight used in an active allotment may not be final, until the service provider has actually delivered or measured the active allotment. Different service providers may have different practices. In some embodiments, the service provider may measure the active allotment at original location, e.g., MSP airport. In some other embodiments, the service provider may measure the active allotment at destination location, LAX airport. In another embodiment, the service provider may measure the active allotment at some point before the active allotment is delivered. Once the actual weight used in an active allotment is measured, the service provider may update the actual weight used in an active allotment and the status of the actual weight used in an active allotment may be deemed final.

As shown in FIG. 3, at block 320, the processor waits for a period of time, if the actual weight used in the active allotment is not final. The method 300 proceeds back to block 310 after 320.

As shown in FIG. 3, at block 325, processor calculates an allotment due amount using the actual weight used in an active allotment and a contract rate for each unit weight. In one embodiment, the active allotment due amount can be calculated as: actual weight used in the active allotment×contract rate for each unit weight.

FIG. 4 is a flow chart illustrating a method 400 to create a supplemental air waybill (AWB) according to one embodiment of the disclosure. The method 400 may include, be used as part, or be used in combination with the method 100 in FIG. 1. For example, the method 400 may be an alternative embodiment of method 100 in FIG. 1. The method 400 may include, be used as part, or be used in combination with the method 200 in FIG. 2. For example, the method 200 in FIG. 2 may be an alternative embodiment of 410, 415 and 420 of the method 400. The method 400 may include, be used as part, or be used in combination with the method 300 in FIG. 3. The method 400 may include, be used as part, or be used in combination with the method 500 in FIG. 5. For example, method 500 in FIG. 5 may be an alternative embodiment of method 400. The method 400 may include or be implemented in the user interface 600 in FIG. 6. For example, without limitation, the soft/hard block 625, soft block % due 620, and approximate flight departure time 630 may be part of the information collected at block 415. The method 400 can be implemented in the system 700 as shown in FIG. 7. For example, without limitation, the instructions implementing method 400 may be stored in the data storage 706 or displayed on the user interface device 710. The method 400 can be implemented in the computer system 800 as shown in FIG. 8. For example, without limitation, the instructions implementing method 400 may be executed by the CPU 802 as shown in FIG. 8. The method 400 can be implemented on the servers 900 and 950 as shown in FIGS. 9A and 9B. For example, without limitation, the instructions implementing method 400 may be generated in the emulated environment 908 in as shown in FIG. 9A or executed by the CPU 913 as shown in FIG. 9B.

As shown in FIG. 4, the method 400 starts at block 405. The method 400 proceeds to block 410, which includes determining, by the processor, whether the allotment contract is an HB or an SB contract. The method 400 proceeds to block 415, which includes collecting, at the processor, allotment contract information. The method 400 proceeds to block 420, which includes calculating, at the processor, an allotment total due amount according to the contract information. The method 400 proceeds to block 425, which includes collecting, at the processor, active allotment information. The method 400 proceeds to block 430, which includes determining, at the processor, whether weight commitment is equal or greater than actual weight used in an active allotment. The method 400 proceeds to block 435, which includes calculating, at the processor, an underutilized allotment fee using one the following equation: (1) underutilized allotment fee=allotment total due amount−active allotment due amount, if the allotment contract is an HB contract; and (2) underutilized allotment fee=(allotment total due amount−active allotment due amount)×underutilized allotment percentage rate, if the allotment contract is an SB contract. The method 400 proceeds to block 440, which includes creating, by the processor, a supplemental air waybill (AWB) that includes the underutilized allotment fee. The method 400 proceeds to block 445, which includes creating, by the processor a reference number for the supplemental AWB. The method 400 proceeds to block 450, which includes documenting, by the processor, the supplemental AWB.

As shown in FIG. 4, at block 410, the processor determines whether the allotment contract is an HB or an SB. In some embodiments, one difference between an HB or an SB is the way to calculate an underutilized allotment fee. In one embodiment, if the allotment contract is an HB, the underutilized allotment fee=allotment total due amount−active allotment due amount. For example, in one HB, if the allotment total due amount is $2000 and the active allotment due amount is $1992, then the underutilized allotment fee is $2000−$1992=$8.

In another embodiment, if the allotment contract is an SB, underutilized allotment fee=(allotment total due amount−active allotment due amount)×underutilized allotment percentage rate. For example, in one SB, if the allotment total due amount is $2000, the active allotment due amount is $1992, and the underutilized allotment percentage rate is 100/%, then the underutilized allotment fee is ($2000−$1992)×10%=$8.

As shown in FIG. 4, at block 415, the processor collects allotment contract information. The collected information may include weight commitment, contract rate for each unit weight, underutilized allotment percentage rate, flight departure time, change allotment deadline, original location, destination location, etc. It is noted the information collected at block 415 is not limited to the information listed in this paragraph. Any information may be specified in an allotment contract may be collected at block 415. An alternative embodiment of block 415 may be the block 110 in FIG. 1.

As shown in FIG. 4, at block 420, the processor calculates an allotment total due amount according to the contract information. At block 420, the allotment total due amount may be calculated in any manner as agreed between the service provider and service requester. In one embodiment, the allotment total due amount may be calculated as: allotment total due amount=weight commitment×contract rate for each unit weight.

As shown in FIG. 4, at block 425, the processor collects active allotment information. The active allotment information may include actual weight used in an active allotment, etc. It is noted any information about the allotment actually being used by the service requester can be collected at block 425. In one embodiment, any information about the active allotment that is measured by the service provider, e.g., size, weight, density, etc. can be the active allotment information referred in block 425.

As shown in FIG. 4, at block 430, the processor determines whether the weight commitment is equal or greater than actual weight used in an active allotment. In one embodiment, the determination at block 430 may be useful in an HB or SB contract that has a strict commitment on weight. The strict commitment on weight means an underutilized allotment fee shall incur as long as the service requester does not fulfill the weight commitment. At 430, if weight commitment is equal or greater than the actual weight used in an active allotment, the method 400 proceeds to block 435. If weight commitment is less than the actual weight used in an active allotment, then the method 400 may proceed to other appropriate steps without limitation.

As shown in FIG. 4, at block 435, if weight commitment is equal or greater than the actual weight used in an active allotment, then the processor calculates an underutilized allotment fee using one of the following equations: (1) underutilized allotment fee=allotment total due amount−active allotment due amount, if the allotment contract is an HB contract; and (2) underutilized allotment fee=(allotment total due amount−active allotment due amount)×underutilized allotment percentage rate, if the allotment contract is an SB contract.

As shown in FIG. 4, at block 440, the processor creates a supplemental air waybill (AWB) that includes the underutilized allotment fee. In one embodiment, the supplemental AWB may include other charges to the service requester other than the underutilized allotment fee, for example, booking weight charges, shipping taxes, special handling fees, etc. In one embodiment, the supplemental AWB may be billed to the service requester after the goods are shipped. In another embodiment, the supplemental AWB may be billed to the service requester before the goods are shipped.

As shown in FIG. 4, at block 445, the processor creates a reference number for the supplemental AWB. In one embodiment, this reference number may be used to track the supplemental AWB in an accounting system.

As shown in FIG. 4, at block 450, the processor documents the supplemental AWB. In embodiment, the supplemental AWB may be documented by storing the relevant information and reference number in a computer system, e.g., the computer system 800.

FIG. 5 is a flow chart illustrating a method 500 to create a supplemental AWB according to one embodiment of the disclosure. The method 500 may include, be used as part, or be used in combination with the method 100 in FIG. 1. For example, the method 500 may be an alternative embodiment of method 100 in FIG. 1. The method 500 may include, be used as part, or be used in combination with the method 200 in FIG. 2. For example, the method 200 in FIG. 2 may be an alternative embodiment of 510 and 515 of the method 500. The method 500 may include, be used as part, or be used in combination with the method 300 in FIG. 3. For example, the method 300 in FIG. 3 may be an alternative embodiment of 520, 525, and 535 of the method 500. The method 500 may include, be used as part, or be used in combination with the method 400 in FIG. 4. For example, method 500 in FIG. 5 may be an alternative embodiment of method 400 in FIG. 4. The method 500 may include or be implemented in the user interface 600 in FIG. 6. For example, without limitation, the soft/hard block 625, soft block % due 620, and approximate flight departure time 630 may be part of the information collected at block 510. The method 500 can be implemented in the system 700 as shown in FIG. 7. For example, without limitation, the instructions implementing method 500 may be stored in the data storage 706 or displayed on the user interface device 710. The method 500 can be implemented in the computer system 800 as shown in FIG. 8. For example, without limitation, the instructions implementing method 500 may be executed by the CPU 802 as shown in FIG. 8. The method 500 can be implemented on the servers 900 and 950 as shown in FIGS. 9A and 9B. For example, without limitation, the instructions implementing method 500 may be generated in the emulated environment 908 in as shown in FIG. 9A or executed by the CPU 913 as shown in FIG. 9B.

As shown in FIG. 5, at block 510, the processor gathers allotment contract information. Alternative embodiments of block 510 may include blocks 110, 410, and 415. Alternative embodiments of block 510 may include method 200 in FIG. 2. The contract information collected at block 510 may include e.g., weight commitment, contract rate for each unit weight, underutilized allotment percentage rate, flight departure time, change allotment deadline, original location, destination location, etc.

As shown in FIG. 5, at block 515, the processor calculates an allotment total due amount according to the allotment contract information. Alternative embodiments of block 515 may include blocks 420 and 115. Alternative embodiments of block 515 may include example 200 in FIG. 2.

As shown in FIG. 5, at block 520, the processor gathers active allotment information. Alternative embodiments of block 520 may include blocks 120 and 425. Alternative embodiments of block may include method 300 in FIG. 3.

As shown in FIG. 5, at block 525, the processor determines whether the active allotment information is final. In one embodiment, a logistic managing system may automatically populate an active allotment information based on what is claimed by the service requester. However, the actual weight used in an active allotment may not be final, until the service provider or an intermediate carrier has actually delivered/measured the active allotment. Different service providers may have different practices. In some embodiments, the active allotment may be measured at original location, e.g., MSP airport. In some other embodiments, the active allotment may be measured at destination location, LAX airport. In another embodiment, the active allotment may be measured at some point before the active allotment is delivered. Once the actual weight used in an active allotment is measured, the service provider may update the actual weight used in an active allotment and the status of the actual weight used in an active allotment may be deemed final.

As shown in FIG. 5, at block 530, if the active allotment information is not final, the processor waits for a period of time. In embodiment, the purpose for waiting for a period of time at block 530 is to make sure that the active allotment due amount at 535 is calculated according to the finalized active allotment information.

As shown in FIG. 5, at block 535, the processor calculates an active allotment due amount according to the active allotment information. Alternative embodiments of 535 may include block 130 and method 300.

As shown in FIG. 5, at block 540, the processor determines whether an underutilized allotment fee is incurred. Alternative embodiments of block 540 may include blocks 130 and 430. In one embodiment, the underutilized allotment fee may be calculated as: (1) underutilized allotment fee=allotment total due amount−active allotment due amount, if the allotment contract is an HB contract; and (2) underutilized allotment fee=(allotment total due amount−active allotment due amount)×underutilized allotment percentage rate, if the allotment contract is an SB contract.

As shown in FIG. 5, at block 545, if no underutilized allotment fee is incurred, the processor creates a supplemental AWB that does not include the underutilized allotment fee. In one embodiment, the supplemental AWB may include other charges to the service requester other than the underutilized allotment fee, for example, booking weight charges, shipping taxes, special handling fees, etc.

As shown in FIG. 5, at block 550, if underutilized allotment fee is incurred, the processor creates a supplemental AWB that includes the underutilized allotment fee. In one embodiment, the supplemental AWB is in addition to a regular bill for the active allotment.

As shown in FIG. 5, at block 555, the processor creates a reference number for the supplemental AWB. In one embodiment, this reference number may be used to track the supplemental AWB in an accounting system.

As shown in FIG. 5, at block 560, the processor documents the supplemental AWB. In one embodiment, the supplemental AWB may be documented by storing the relevant information and reference number in a computer system, e.g., the computer system 800.

FIG. 6 is a user interface 600 showing allotment contract information according to one embodiment of the disclosure. The user interface 600 may include or be included in the method 100 in FIG. 1. The user interface 600 may include or be included in the method 200 in FIG. 2. The user interface 600 may include or be included in the method 300 in FIG. 3. The user interface 600 may include or be included in the method 400 in FIG. 4. The user interface 600 may include or be included in the method 500 in FIG. 5. The user interface 600 can be implemented in the system 700 as shown in FIG. 7. For example, without limitation, the instructions implementing user interface 600 may be stored in the data storage 706 or displayed on the user interface device 710. The user interface 600 can be implemented in the computer system 800 as shown in FIG. 8. For example, without limitation, the instructions implementing user interface 600 may be executed by the CPU 802 as shown in FIG. 8. The user interface 600 can be implemented on the servers 900 and 950 as shown in FIGS. 9A and 9B. For example, without limitation, the instructions implementing user interface 600 may be generated in the emulated environment 908 in as shown in FIG. 9A or executed by the CPU 913 as shown in FIG. 9B.

The block 605 may include weight information. In one embodiment, block 605 may include information of weight commitment and may be collected at blocks 110, 215, 415, and 510. In another embodiment block 605 may include information of actual weight used in an active allotment, and may be collected at blocks 120, 310, 425, and 520.

The block 610 may include dimension information and may be collected at blocks 110, 215, 415, and 510. In another embodiment, block 610 may include information of active allotment dimension, and may be collected at block 120, 425, and 520.

The block 615 may include information of allotment tolerance. In one embodiment block 615 may include underbooking/overbooking tolerance. In another embodiment, block 615 may include underutilized allotment tolerance. The allotment tolerance in block 615 may be specified in weight, volume, or both.

The block 625 may include the information of HB or SB. In one embodiment, the information of block 625 may be collected at blocks 110, 210, 410, and 510.

The block 620 may include information of underutilized allotment percentage rate of an SB contract. In one embodiment, block 620 specifies the underutilized allotment percentage rate (e.g., 1˜99%) in a SB contract. In one embodiment, block 620 is enabled, only if SB was selected in 625.

The block 630 may include approximate flight departure time. In one embodiment, the approximate flight departure time is recorded in 30 minutes interval.

The block 635 may include change allotment deadline. In one embodiment, the change allotment deadline may be specified in terms of hours before approximate flight departure time in block 630, e.g., 48 hours before approximate flight departure time.

The block 640 may include dimensional weight. This dimensional weight is measured according to industrial standard. A person skilled in the art would understand the different rules, regulations, and methods in calculating the dimensional weight without further disclosures.

The block 645 may include allotment total due amount.

FIG. 7 is a block diagram illustrating a system 700 according to one embodiment of the disclosure according to one embodiment of the disclosure. FIG. 7 illustrates a system 700 for obtaining access to database files in a computing system according to one embodiment of the disclosure. The system 700 may include a server 702, a data storage device 706, a network 708, and an user interface device 710. The server 702 may also be a hypervisor-based system executing one or more guest partitions hosting operating systems with modules having server configuration information. In a further embodiment, the system 700 may include a storage controller 704, or a storage server configured to manage data communications between the data storage device 706 and the server 702 or other components in communication with the network 708. In an alternative embodiment, the storage controller 704 may be coupled to the network 708.

In one embodiment, the user interface device 710 is referred to broadly and is intended to encompass a suitable processor-based device such as a desktop computer, a laptop computer, a personal digital assistant (PDA) or tablet computer, a smartphone or other mobile communication device having access to the network 708. In a further embodiment, the user interface device 710 may access the Internet or other wide area or local area network to access a web application or web service hosted by the server 702 and may provide an user interface for enabling an user to enter or receive information.

The network 708 may facilitate communications of data between the server 702 and the user interface device 710. The network 708 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 710 accesses the server 702 through an intermediate sever (not shown). For example, in a cloud application the user interface device 710 may access an application server. The application server fulfills requests from the user interface device 710 by accessing a database management system (DBMS). In this embodiment, the user interface device 710 may be a computer or phone executing a Java application making requests to a JBOSS server executing on a Linux server, which fulfills the requests by accessing a relational database management system (RDMS) on a mainframe server.

FIG. 8 is a block diagram illustrating a computer system 800 according to one embodiment of the disclosure. FIG. 8 illustrates a computer system 800 adapted according to certain embodiments of the server 702 and/or the user interface device 710. The central processing unit (“CPU”) 802 is coupled to the system bus 804. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 may also include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 may also include an I/O adapter 810, a communications adapter 814, an user interface adapter 816, and a display adapter 822. The I/O adapter 810 and/or the user interface adapter 816 may, in certain embodiments, enable an user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a solid state storage device, a flash drive, a compact disc (CD) drive, a floppy disk drive, and a tape drive, to the computer system 800. According to one embodiment, the data storage 812 may be a separate server coupled to the computer system 800 through a network connection to the I/O adapter 810. The communications adapter 814 may be adapted to couple the computer system 800 to the network 708, which may be one or more of a LAN, WAN, and/or the Internet. The user interface adapter 816 couples user input devices, such as a keyboard 820, a pointing device 818, and/or a touch screen (not shown) to the computer system 800. The display adapter 822 may be driven by the CPU 802 to control the display on the display device 824. Any of the devices 802-822 may be non-emulated and/or emulated.

The applications of the present disclosure are not limited to the architecture of computer system 800. Rather the computer system 800 is provided as an example of one type of computing device that may be adapted to perform the functions of the server 702 and/or the user interface device 810. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 800 may be virtualized for access by multiple users and/or applications.

FIG. 9A is a block diagram illustrating a server 900 hosting an emulated software environment for virtualization according to one embodiment of the disclosure. An operating system 902 executing on a server 900 includes drivers for accessing hardware components, such as a networking layer 904 for accessing the communications adapter 914. The operating system 902 may be, for example, Linux or Windows. An emulated environment 908 in the operating system 902 executes a program 910, such as Communications Platform (CPComm) or Communications Platform for Open Systems (CPCommOS). The program 910 accesses the networking layer 904 of the operating system 902 through a non-emulated interface 906, such as extended network input output processor (XNIOP). The non-emulated interface 906 translates requests from the program 910 executing in the emulated environment 908 for the networking layer 904 of the operating system 902.

In another example, hardware in a computer system may be virtualized through a hypervisor. FIG. 9B is a block diagram illustrating a server 950 hosting an emulated hardware environment according to one embodiment of the disclosure. Users 952, 954, 956 may access the hardware 960 through a hypervisor 958. The hypervisor 958 may be integrated with the hardware 958 to provide virtualization of the hardware 958 without an operating system, such as in the configuration illustrated in FIG. 9A. The hypervisor 958 may provide access to the hardware 958, including the CPU 913 and the communications adaptor 914.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
collecting, by a processor, allotment contract information;
calculating, by the processor, an allotment total due amount using the allotment contract information;
collecting, by the processor, active allotment information;
calculating, by the processor, an active allotment due amount using the active allotment information; and
calculating, by the processor, an underutilized allotment fee using the allotment total due amount and the active allotment due amount.

2. The method according to claim 1, wherein the step of collecting, by a processor, allotment contract information further includes
determining, by the processor, whether an allotment contract is a hard block (HB) contract or a soft block (SB) contract; and
determining, by the processor, a weight commitment of the allotment contract.

3. The method according to claim 2, wherein the step of calculating, by the processor, an underutilized allotment fee using the allotment total due amount and the active allotment due amount further includes using the following equations:
underutilized allotment fee=allotment total due amount−active allotment due amount, if the allotment contract is an HB contract; and
underutilized allotment fee=(allotment total due amount−active allotment due amount)×underutilized allotment percentage rate, if the allotment contract is an SB contract.

4. The method according to claim 1, wherein the step of calculating, by the processor, an allotment total due amount using the allotment contract information further includes using the following equation:
allotment total due amount=weight commitment×contract rate for each unit weight.

5. The method according to claim 1, wherein the step of collecting, by the processor, active allotment information further includes,
gathering, at the processor, an actual weight used in an active allotment.

6. The method according to claim 1, wherein the step of calculating, by the processor, an active allotment due amount using the active allotment information further includes using the following equation:
active allotment due amount=actual weight used in an active allotment×contract rate for each unit weight.

7. The method according to claim 1, wherein the step of calculating, by the processor, an underutilized allotment fee using the allotment total due amount and the active allotment due amount further includes using the following equation:
underutilized allotment fee=allotment total due amount−active allotment due amount.

8. A computer program product, comprising:
a non-transitory computer-readable medium comprising instructions which, when executed by a processor of a computing system, cause the processor to perform the steps of:
collecting allotment contract information;
calculating an allotment total due amount using the allotment contract information;
collecting active allotment information;
calculating an active allotment due amount using the active allotment information; and
calculating an underutilized allotment fee using the allotment total due amount and the active allotment due amount.

9. The computer program product of claim 8, wherein the step of collecting allotment contract information further includes
determining whether an allotment contract is a hard block (HB) contract or a soft block (SB) contract; and
determining a weight commitment of the allotment contract.

10. The computer program product of claim 9, wherein the step of calculating an underutilized allotment fee using the allotment total due amount and the active allotment due amount further includes using the following equations:
underutilized allotment fee=allotment total due amount−active allotment due amount, if the allotment contract is an HB contract; and
underutilized allotment fee=(allotment total due amount−active allotment due amount)×underutilized allotment percentage rate, if the allotment contract is an SB contract.

11. The computer program product of claim 8, wherein the step of calculating an allotment total due amount using the allotment contract information further includes using the following equation:
allotment total due amount=weight commitment×contract rate for each unit weight.

12. The computer program product of claim 8, wherein the step of collecting active allotment information further includes
gathering an actual weight used in an active allotment.

13. The computer program product of claim 8, wherein the step of calculating an active allotment due amount using the active allotment information further includes using one of the following equations:
active allotment due amount=actual weight used in the active allotment×contract rate for each unit weight.

14. The computer program product of claim 8, wherein the step of calculating an underutilized allotment fee using the allotment total due amount and the active allotment due amount further includes using one of the following equations:
underutilized allotment fee=allotment total due amount−active allotment due amount.

15. An apparatus, comprising:
a memory; and
a processor coupled to the memory, the processor configured to execute the steps of:
collecting allotment contract information;
calculating an allotment total due amount using the allotment contract information;
collecting active allotment information;
calculating an active allotment due amount using the active allotment information; and
calculating an underutilized allotment fee using the allotment total due amount and the active allotment due amount.

16. The apparatus of claim 15, wherein the step of collecting allotment contract information further includes
determining whether an allotment contract is a hard block (HB) contract or a soft block (SB) contract; and
determining a weight commitment of the allotment contract.

17. The apparatus of claim 16, wherein the step of calculating an underutilized allotment fee using the allotment total due amount and the active allotment due amount further includes using the following equations:
underutilized allotment fee=allotment total due amount−active allotment due amount, if the allotment contract is an HB contract; and
underutilized allotment fee=(allotment total due amount−active allotment due amount)×underutilized allotment percentage rate, if the allotment contract is an SB contract.

18. The apparatus of claim 15, wherein the step of calculating an allotment total due amount using the allotment contract information further includes using the following equation:
allotment total due amount=weight commitment×contract rate for each unit weight.

19. The apparatus of claim 15, wherein the step of collecting active allotment information further includes
gathering an actual weight used in an active allotment.

20. The apparatus of claim 15, wherein the step of calculating an active allotment due amount using the active allotment information further includes using one of the following equations:
active allotment due amount=actual weight used in an active allotment×contract rate for each unit weight.

21. The apparatus of claim 15, wherein the step of calculating an underutilized allotment fee using the allotment total due amount and the active allotment due amount further includes using one of the following equations:
underutilized allotment fee=allotment total due amount−active allotment due amount.
